(19) United States
(12) Patent Application Publication
(10) Pub. No.: US 2006/0200754 A1
(43) Pub. Date: Sep. 7, 2006

(54) Systems and methods for storing personal information, automatically filling out forms, and sharing information with a data recipient

(75) Inventors: Scott S. Kablesh, San Antonio, TX (US); Louis J. Trotter JR., Bethesda, MD (US); Ellen Kirsh, Potomac, MD (US); Justin L. Taylor, Alexandria, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: INFOSNAP

(21) Appl. No.: 11/408,204

(22) Filed: Apr. 21, 2006

Related U.S. Application Data
(63) Continuation of application No. 09/983,367, filed on Oct. 24, 2001.

(51) Int. Cl. G06F 17/00

(52) U.S. Cl. 715/505; 715/700

(57) ABSTRACT

Systems and methods provide for receiving form information from a user or a data recipient and then reuses the information to provide other forms with the information regardless of whether the other forms belong to the data recipient or a different data recipient. The systems and methods also provide for electronically sharing form information, administrative information, and other information with the data recipient. Further, the systems and methods provide for tracking and reporting information about the completion status of forms.

### FIELD OF THE INVENTION

The present invention is directed to information collection and retrieval systems and, more particularly, to systems and methods that reuse personal information collected from users to electronically fill out forms and to share the information in the forms with data recipients.

### BACKGROUND OF THE INVENTION

Conventional methods for filling out forms, such as application or registration forms, involve a two step process. First, a person filling out a form manually inputs the requested information into the form, such as by handwriting the information into the form, entering the data into an electronic version of the form, or using a typewriter to type the data into the form. After filling out the form, he or she sends the form to a data recipient for processing of the form. Data recipients include people or entities that produce forms and solicit information from other people for filling out the forms. The data recipients may include, for example, camps, schools, car rental companies, doctors, soccer leagues, community organizations, member based associations, etc.

Second, once the data recipient receives the form, the data recipient has to either manually enter the information from the form into a database, or if the form is in electronic format, manipulate or massage the information (such as by parsing) to format it into a specific database configuration prior to transferring the information to the database.

Two basic problems exist with such conventional methods. First, each time the person needs to fill out a form with a data recipient, such as school A, she must input information that she has already supplied in filling out a previous form with school A. In addition, if she now wants to complete a form provided by school B, she must again repeat information that she has already supplied to school A. In other words, the person wastes time and effort in filling out such forms by entering the same information multiple times.

Second, personnel resources are needed to manually enter data from the forms into a database or to manipulate the data in an electronic version of the form in order to place the data into a format suitable for storage in a database. This results in a loss of efficiency, introduces the possibility of data entry or data manipulation errors, adds cost, and introduces delays.

One known system for entering personal data in electronic markets is described in U.S. Pat. No. 5,987,440. The system described in that patent provides for sharing a user's personal information with third parties based upon rules that are defined by the user. In that system, however, the user must associate access rules with each piece of information that she wishes to supply to a third party. Further, each time that a change is made to a form to require an additional item of personal information, the user must associate access rules with the information to allow the third party to access the information.

A known method for providing for the creation and editing of forms is described in U.S. Pat. No. 5,844,971. The methods described in that patent provide for allowing a user to make a telephone call to an ordering system to request a predetermined number of forms, specify a selected delivery mode, provide identification information, and to indicate whether the forms should be customized. However, the methods do not provide for reusing information that has already been supplied in a prior form. Further, the methods do not provide for reusing information supplied by the user to one data recipient to fill out a form for a different data recipient. Moreover, such systems and methods do not provide for sharing information with data recipients.

A known method for automatically filling out Web-based forms is described in U.S. Pat. No. 6,192,380 B1. The system disclosed in that patent provides for automatically filling out Web-based forms based on “tags” associated with data stored in a database, and based on a user-requested authorization level that restricts the access of the data to specified Web sites. In that system the user must associate tags with the data for the system to “learn” the association of the tag to the data. Further, users must associate authorization levels to restrict the access of information to user specified Web sites. Therefore, each time that a data recipient makes a change to a form to require an additional item of personal information, the user must associate a tag and/or access authorization level with the information. In addition, the methods do not provide for automatically saving the information on a page-by-page basis, but only saves the information when the user indicates that the user has completed filling out a form. Thus, if an interrupt occurs when a user has only completed a portion of the form, the user will lose any data that she has supplied to the form and has to renter such data in a subsequent session on the system.

A known product for filling out forms on the Web is Gator by Gator.com. Gator uses information stored on a user's local computer to fill out electronic forms, such as online order forms. Thus, a user has to use his own computer each time that he wishes to reuse information that he has already provided to an electronic form, otherwise the user will have to resupply to Gator information that he has already provided in the electronic form. In addition, Gator does not provide for sharing electronic form information with a data recipient through imports or exports of electronic form information.

Another known product for filling out forms on the Web is PreEnroll by PreEnroll, Inc. PreEnroll uses information stored on a user's local computer, in the form of a “cookie,” to fill out electronic forms for organizations such as a sports league. A “cookie” may be a text file that is stored on a user's local computer, and may include information that was previously supplied to a Web server. The information may include personal information about the user. Typically, a user will access a Web browser to communicate with a Web server, and the Web browser may transmit the cookie to the Web server for use in providing information to a Web page. Thus, like Gator, a user has to use his own computer (or a computer that has the user's cookie file thereon) each time that he wishes to reuse information that he has already provided to an electronic form, otherwise the user will have to resupply to PreEnroll information that he has already provided in the electronic form. In addition, PreEnroll does not provide for sharing electronic form information with a data recipient through imports or exports of electronic form information.

### SUMMARY OF THE INVENTION

Systems and methods consistent with the present invention provide for automatically filling out an electronic form. Such systems and methods generate an electronic form; store a set of information for the electronic form; receive a request for access to the electronic form; retrieve the set of information for the electronic form; place the retrieved set of information into the electronic form; display the electronic form; receive updated information in the electronic form; and store the updated information in the data storage in the set of information for use in filling out the electronic form.

Systems and methods consistent with the present invention also provide for automatically supplying electronic form information to a data recipient. Such systems and methods receive a request from the data recipient for the electronic form information; retrieve the requested electronic form information; format the requested electronic form information in a format specified by the data recipient; and send the formatted electronic form information to the data recipient.

In addition, systems and methods consistent with the present invention provide for using a first set of information from a first electronic form belonging to a first data recipient to provide information to a second electronic form. Such systems and methods receive a request for the second electronic form, wherein the second electronic form belongs to a second data recipient; retrieve the first set of information for the first electronic form when fields in the first electronic form match the fields in the second electronic form; and place the retrieved first set of information for the first electronic form into the matching fields of the second electronic form.

### BRIEF DESCRIPTION OF THE DRAWINGS

The accompanying drawings, which are incorporated in and constitute a part of this specification, illustrate an embodiment of the invention and, together with the description, explain the invention. In the drawings:

FIG. 1 is a block diagram of a system consistent with the present invention;

FIG. 2 is a block diagram of a computer form system consistent with the present invention;

FIG. 3 is a block diagram of a data recipient system consistent with the present invention;

FIG. 4a is a flowchart showing processing for an implicit registration mode;

FIG. 4b is a flowchart showing processing for an explicit registration mode;

FIG. 5 is a flowchart showing processing of forms;

FIG. 6 is a flowchart showing the data flow of information within a system;

FIG. 7 is a flowchart showing processing for sharing information with a data recipient having a management information system;

FIG. 8 is a flowchart showing processing for sharing information with a data recipient that does not have a management information system;

FIG. 9 is a block diagram of a Web page for displaying form tracking information for forms that are produced by or in a form system; and

FIG. 10 is a block diagram of a Web page for displaying form tracking information for forms that are filled out externally from a form system.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Systems and methods consistent with the present invention simplify the process of filling out forms and provide for organizing and sharing information from forms with data recipient. This allows an end user to fill out a form once, and for subsequent forms, to automatically place in the forms information previously supplied by the user or a data recipient. Users can then update the form and/or print it, and submit it to a data recipient. The data recipient may be notified of updates to a user's form. The notifications may be provided on a real-time basis. The updated data may be transmitted to a requesting data recipient. In addition, such systems and methods provide for organizing and sharing form information with data recipients, thereby reducing administration costs to such data recipients.

### System Description

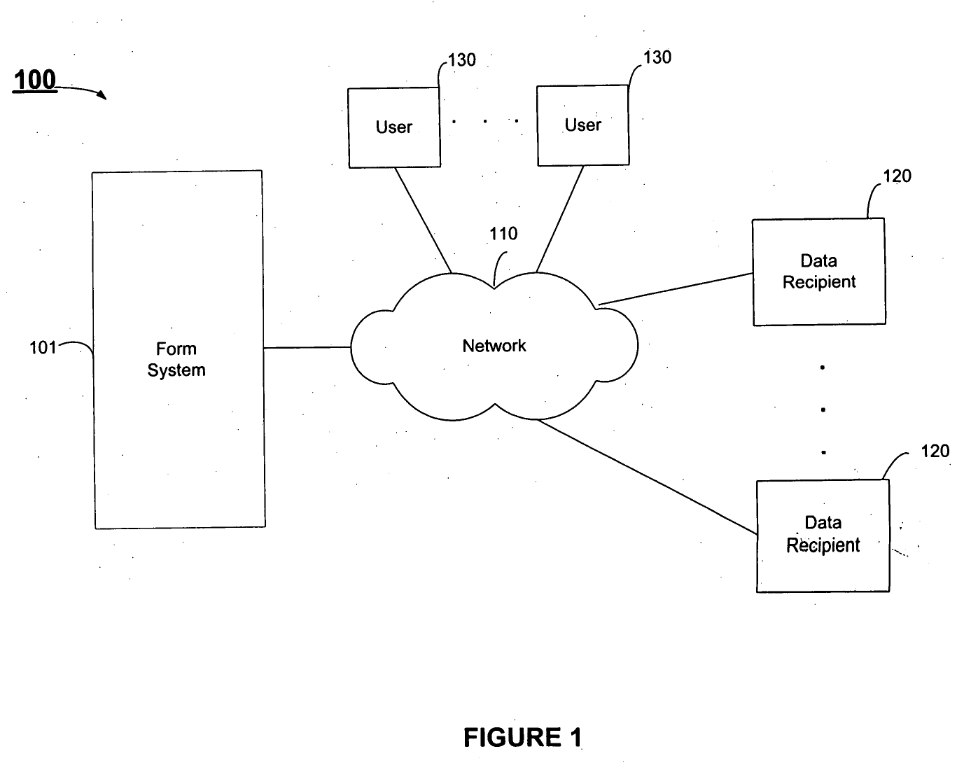

FIG. 1 is a block diagram of an exemplary system with which the invention may be implemented. A system 100 may include a form system 101, a network 110, a plurality of data recipients 120, and a plurality of users 130. A form system 101 may include any computer or processor, such as a personal computer, a hand-held computer, or a laptop computer. Form system 101 communicates with a plurality of users 130 and data recipients 120 over network 110. The network 110 may include, for example, a Local Area Network (LAN), a Wide Area Network (WAN), a wireless network, the Internet, an intranet, and/or any other network or communication medium known to one of ordinary skill in the relevant art. Communications between form system 101, data recipients 120, and users 130 may take place over network 110 through a secure sockets layer (“SSL”) protocol or secure HyperText Transfer Protocol (“S-HTTP”).

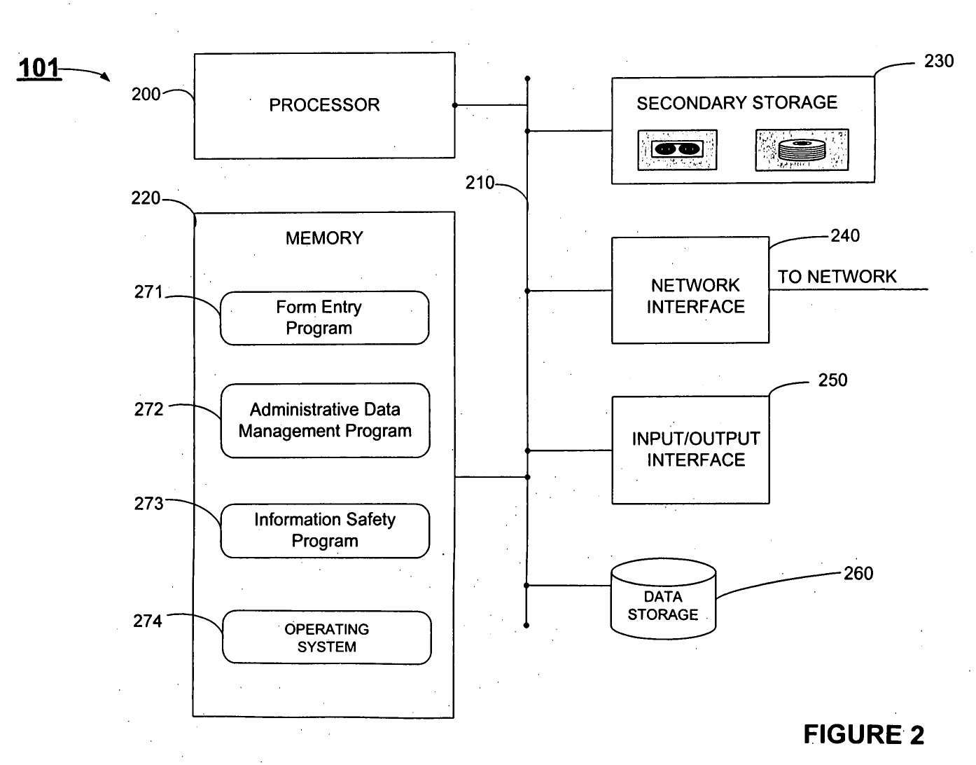

FIG. 2 is a block diagram of an exemplary system architecture for a form system 101 with which the invention may be implemented. A form system 101 may include a processor 200, which connects over a bus 210 to a memory 220, a secondary storage 230, a network interface module 240, an input/output interface module 250, and a data storage 260. Memory 220 may include a form entry program 271, an administrative data management program 272, and an operating system 274, each of which will be described below in detail. A memory 220 may optionally include an information safety program 273, which will be described below in detail.

Operation of a form system 101 is generally controlled and coordinated by an operating system 274. The operating system 274 controls allocation of system resources and performs tasks, such as memory management, process scheduling, networking, and services, among other things.

Secondary storage 230 may include a computer-readable medium, such as a disk drive and a compact disc (“CD”) drive or a read/write CD drive. From the CD drive or the read/write CD drive, software and data may be loaded onto the disk drive, which may then be copied into a memory 220. Similarly, software and data in a memory 220 may be copied onto the disk drive, which may then be loaded onto a read/write CD drive.

Network interface module 240 may include hardware and software for sending and receiving data over a network 110. Input/Output interface module 250 may include, for example, one or more of a keyboard, a pointing device, or a keypad, a display unit, or a printing device. A data storage 260 may include one or more databases and/or data files for storage of registration information, forms, management information, reports, accounting information, etc.

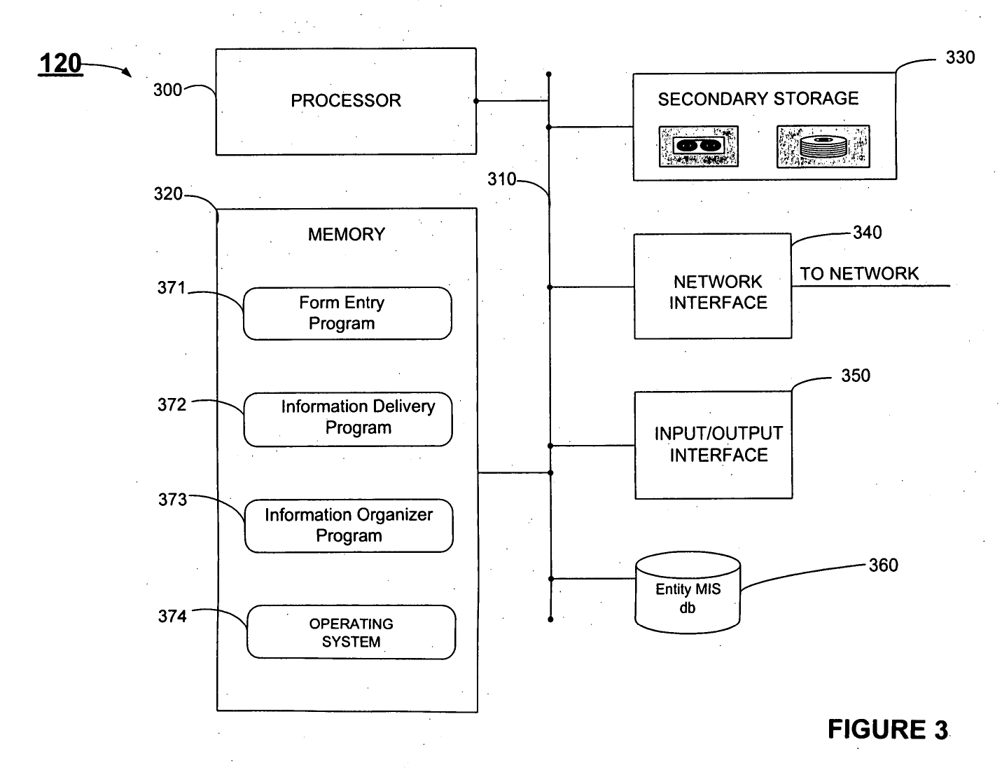

FIG. 3 is a block diagram of an exemplary system architecture for a data recipient 120 with which the invention may be implemented. A system for a data recipient 120 may include a processor 300, which connects over a bus 310 to a memory 320, a secondary storage 330, a network interface module 340, an input/output interface module 350, and an optional entity MIS database 360. A memory 320 may include a form entry program 371, an information delivery program 372 or an information organizer program 373, and an operating system 374, each of which will be described below in detail.

Operation of data recipient system 120 is generally controlled and coordinated by operating system 374. Operating system 374 controls allocation of system resources and performs tasks, such as memory management, process scheduling, networking, and services, among other things.

Secondary storage 330 may include a computer-readable medium, such as a disk drive and a CD drive or a read/write CD drive. From the CD drive or the read/write CD drive, software and data may be loaded onto the disk drive, which may then be copied into a memory 320. Similarly, software and data in a memory 320 may be copied onto the disk drive, which may then be loaded onto a read/write CD drive.

Network interface module 340 may include hardware and software for sending and receiving data over a network 110. Input/Output interface module 350 may include, for example, one or more of a keyboard, a pointing device, or a keypad, a display unit, or a printing device. An entity management information systems (“MIS”) database 360 may include one or more databases for the storage of form information and other information.

### Process Description

The process begins with a request from one or more data recipients 120 to the form system 101 to put the data recipient's 120 forms online. The form system 101 receives a hard copy of one or more forms from the data recipient 120. Alternatively, the form system 101 receives an electronic copy of the forms from the data recipient 120. Each form is reviewed and may be revised by employees or agents of the owners of the form system 100 to simplify the form from an end user's perspective. Next, an electronic form may be generated based on the form. The electronic form may be generated in a format suitable for display by a Web browser, and stored in the form system 101. The format may include, for example, HyperText Markup Language (“HTML”) or Extensible Markup Language (“XML”).

A user 130 may register either directly with the form system 101 to access forms or, indirectly, through a data recipient 120. Once registered with the form system 101, the user 130 may thereafter log into the form system 101 to access and/or fill out forms. The user 130 may be charged a fee for filling out forms through the form system 101, and may be charged a fee by a data recipient 120 for registering with the data recipient 120, such as, for example, a fee for registering to attend a camp session. The user 130 may elect to make payment of any fees through the form system 101 or may pay any fees directly to the data recipient 120. After completing a form, the user 130 may request the form system to print it. The user 130 may then send the completed form to the data recipient 120, or, the form system 101 may send the completed form to the data recipient 120.

### Registration and Form Filling Through a Form Entry Program

Programs 271 and 273 enable users 130 to input information relevant for filling out forms. For convenience, such programs are referred to herein as “form entry” programs. Form entry programs 271 and 371 provide may provide for registering users 130 and data recipients 120 with the form system 101, and assists in filling out forms.

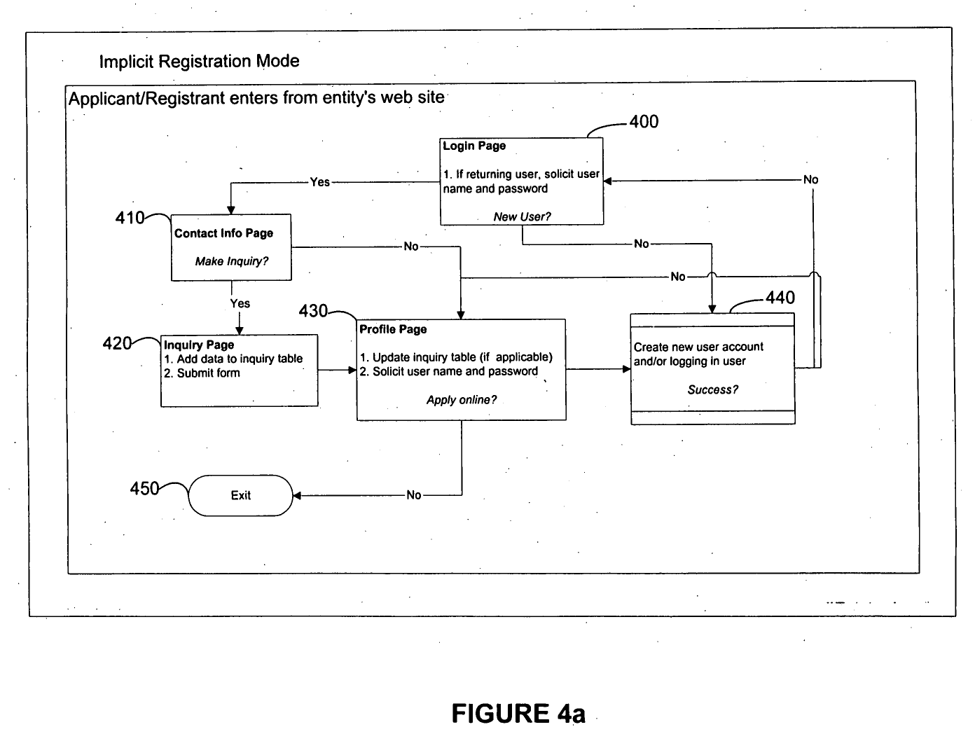

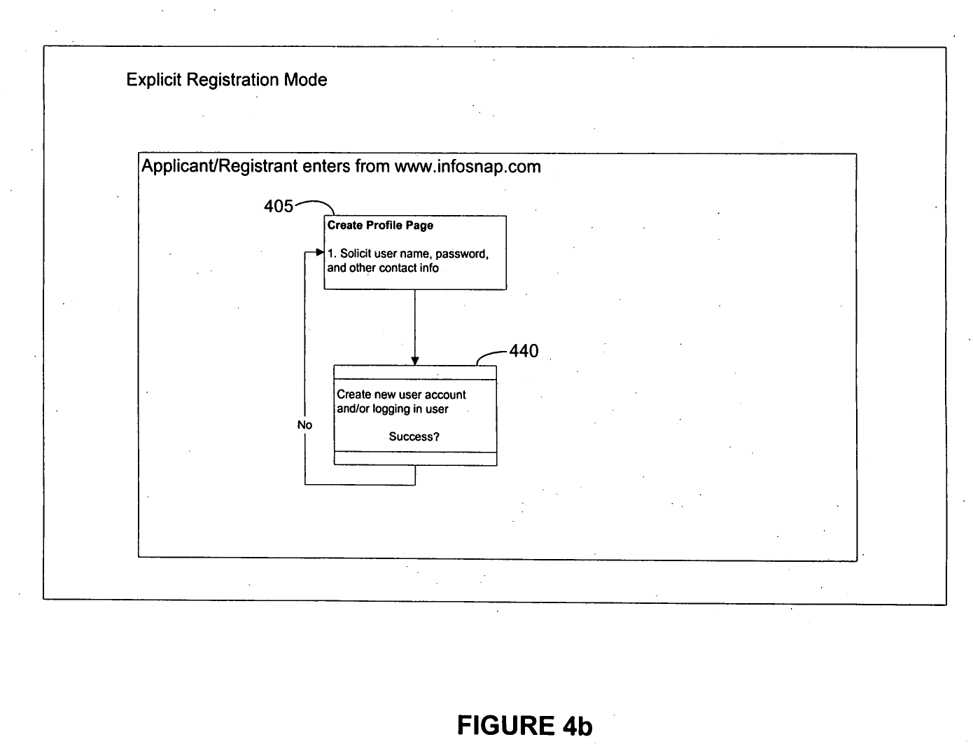

There are two modes for registering a user 130 with the form system 101. A first mode is implicit, wherein a user 130 logs into a data recipient's 120 Web site and provides information that form entry program 371 uses to register the user 130 with the form system 101. FIG. 4a is a flowchart of processing for an implicit registration mode. A data recipient 120 has a hyperlink to an affinity page in the form system's 101 Web site. The affinity page is a Web page that may have the data recipient's 120 logo, name, or other identifying information displayed on the Web page. The affinity page may include, for example, a login page that enables a user 130 to provide registration information.

As shown in FIG. 4a, a user may access a login page to provide registration information, such as a user name and a password, to log in to the form system 101 through form entry program 371 (step 400). If user 130 is a new user, form entry program 371 solicits contact information from the user 130 (step 410). The contact information may include, for example, a postal address, an email address, a telephone number, etc. User 130 may elect to make an inquiry to the data recipient 120 by supplying the inquiry information onto a form and submitting the form (step 420). Form entry program 371 receives the inquiry information and generates an inquiry based on the contact information and the inquiry information. Thereafter, form entry program 371 sends the generated inquiry to the data recipient 120, for example, by an email. If user 130 has not yet supplied a user name and/or password, form entry program 371 prompts user 130 to supply one (step 430). After user 130 has supplied a user name and a password, form entry program 371 creates a login account for user 130 and logs user 130 into form system 101 (step 440). In addition, form entry program 371 stores any contact information supplied by user 130 into data storage 260 through network 110. User 130 may chose to exit from form system 101 at any point during the implicit registration process (step 450).

Otherwise, if user 130 is a returning user, form entry program 371 prompts user 130 to supply a user name and password (step 400). After user 130 has supplied a user name and a password, form entry program 371 attempts to log user 130 into form system 101 (step 440). After user 130 is successfully logged into form system 101, form entry program 371 retrieves contact information for user 130 from data storage 260 through network 110. User 130 may elect to make an inquiry to data recipient 120 by supplying the inquiry information into a form and submitting the form. Form entry program 371 receives the inquiry information generates the inquiry based on the contact information and the inquiry information. Thereafter, form entry program 371 sends the generated inquiry to data recipient 120, for example, by an email. User 130 may chose to exit from form system 101 at any point during the implicit registration process (step 450). Alternatively, user 130 may make revisions, such as updates, to the contact information. Form entry program 371 stores the revisions to the contact information in data storage 260 through network 110.

A second mode is explicit, wherein a user 130 accesses an affinity page provided by form system 101 and supplies registration information to form entry program 271. As shown in FIG. 4b, form entry program 271 solicits a username, password, and contact information from user 130 (step 405). If user 130 is a returning user, form entry program 271 retrieves contact information for user 130 from data storage 260 and inputs the contact information into a form. User 130 may revise the contact information. Form entry program 271 stores revisions to the contact information in data storage 260. After user 130 has supplied a user name and a password, form entry program 271 attempts to log user 130 into form system 101 or, in the case of a new user, creates a new login account and logs user 130 into the new login account (step 440).

Form entry program 271 may temporarily store in secondary storage 230 information supplied by user 130 onto a form until user 130 submits the form. A user may submit information in an electronic form, for example, by clicking on a “Submit” button or on a “Next” page button. Once user 130 reenters the electronic form, any information previously supplied by the user is automatically retrieved from secondary storage 230 and placed in the appropriate fields of the electronic form. This allows user 130 to fill out electronic forms at his own pace. Once a user submits an electronic form, form entry program 271 extracts the information in the electronic form and stores the information in data storage 260. For example, once the user clicks a “Submit” button on an electronic form, the form is posted to form system's 101 Web server. Then form entry program 271 extracts the information from the electronic form and stores the information in data storage 260.

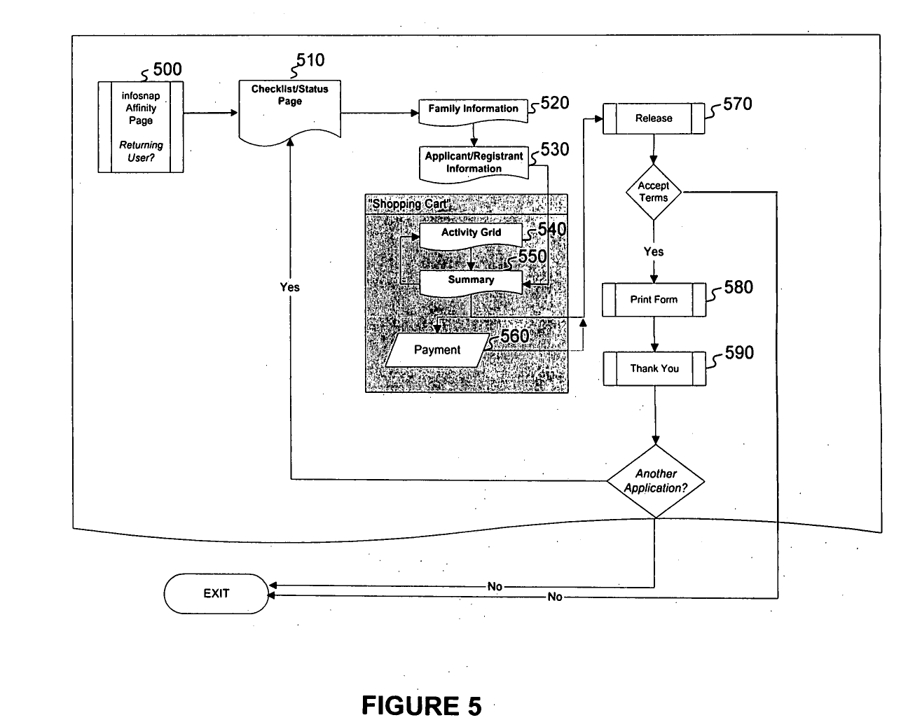

After a user 130 is logged into the form system 101, she may access electronic forms through the process shown in FIG. 5. As FIG. 5 shows, user 130 may access an affinity page through a form system 101 to make one or more requests to a form entry program 271 to access and/or fill out electronic forms (step 500). For example, the user may wish to complete an electronic form to register or re-register to attend a camp belonging to a data recipient.

Form system 101 may provide a checklist/Status page that allows user 130 to select the data recipient 120 from a list of data recipients (step 510). If data recipient 120 has multiple forms, the form entry program 271 may display a list of the electronic forms from which user 130 may select one or more of the electronic forms. The checklist/Status page is a combination of a checklist and a status page that provides a description of the electronic forms that the user filled out or that were imported into the form system 101 environment. In addition, the description of the electronic forms includes a status of each form, such as whether the electronic form is in progress, has been completed and/or submitted, or accepted. Form entry program 271 tracks the status of the electronic forms and graphically displays in the checklist/Status page the steps that are required for filling out a selected electronic form and the progress made towards completing the electronic form. For example, if user 130 returns to continue filling out an electronic form after having completed a portion of the electronic form, the checklist/Status page indicates the required fields that the user must complete prior to submitting the electronic form and indicates the progress made towards completing the electronic form.

Once user 130 has selected an electronic form, form entry program 271 may retrieve information that user 130 previously supplied for the electronic form or information that the form system 101 previously imported for the electronic form relevant to the user 130. If this is the first time that user 130 has requested the selected electronic form through the form system 101, the form entry program 271 may retrieve from data storage 260 information for fields that the form system 101 has previously encountered from other electronic forms for user 130 or through data imports into the form system 101. For example, form entry program 271 queries data storage 260 for one or more electronic forms that have fields that match the electronic form selected by user 130. Form entry program 271 may then supply the fields of the electronic form selected by the user 130 with the data from one or more of the electronic forms with the matching fields. Further, form entry program 271 may retrieve common information for the user 130 selected electronic form from data storage 260 and supply the common fields in the user 130 selected electronic form with the common information. This process of retrieving known data from data storage 260 and supplying it to an electronic form is hereinafter referred to as “snapping” the data into the electronic form.

User 130 may supply family information or change/update existing family information (step 520). In addition, user 130 may supply information about an applicant or change/update such information (step 530). For example, user 130 may supply information about the applicant, such as, for example, a child that the user 130 is registering for a camp. User 130 may select from a predetermined list of activities, for which to register the applicant (step 540). For example, user 130 may select a horseback riding session from 9:30 a.m. to 11:30 a.m. and a swimming session from 1:30 p.m. until 2:30 p.m. Form entry program 271 keeps track of user's 130 selections and costs for the chosen activities and displays them to user 130. Next, user 130 may request a summary (or a report) of the activities that user 130 has selected for the applicant (step 550). User 130 may return to edit/update the information in the electronic form, including the selection of activities.

A data recipient 120 may be notified of updates made by a user 130 to information in a form belonging to the data recipient 120. The notification may be provided on a real-time basis through, for example, an email. Data recipient 120 may request the updated information. Form entry program 271 transmits the updated information to data recipient 120 through network 110.

Once the user 130 completes filling out the electronic form, she may pay any applicable fees electronically through the form entry program 271 (step 560). For example, payment may be made through the form system 101 by the user 130 supplying to the form entry program 271 credit card information over network 110 through a secure socket layer (“SSL”). The fees may include, for example, a fee for using the form system 101, a fee for selected activities, a fee for providing forms for medical emergencies, etc. Alternatively, the user 130 may choose to make payment directly to the data recipient 120, or there may be no fees charged by the data recipient.

Form entry program 271 may display a release page to user 130, which includes the display of any terms and conditions specified by data recipient 120 (step 570). For example, the terms and conditions imposed by a camp or school may be displayed. User 130 may either accept or reject the terms and conditions. If user 130 rejects the terms and conditions (“No”), form entry program 271 exits the user 130 from the form process. If user 130 accepts them (“Yes”), she may request through form entry program 271 to print the electronic form and/or terms and conditions (step 580). Form entry program 271 prints the electronic form and/or terms and conditions. User 130 may request, through a sale page belonging to form system 101, to receive periodic information about form system 101 and the services that form system 101 provides.

Form entry program 271 may remind user 130 to send the electronic form and terms and conditions, if any, to the data recipient 120. User 130 may send the form to data recipient 120 by any known delivery method, such as fax, physical mail, email, etc. Optionally, user 130 may request the form entry program 271 to send the electronic form to data recipient 120. If user 130 has requested form entry program 271 to send the electronic form to data recipient 120, form entry program 271 may apply to the electronic form, an electronic signature for the user 130. Finally, form entry program 271 may display a greeting to user 130, such as “Thank you!” to indicate that the processing for the filling out the form is complete (step 590). The user may select to review or fill out another form.

User 130 may choose to exit the form process at any time and later come back and continue filling out the electronic form at the point where the user 130 exited the form process. In one example, the data that is entered onto an electronic form by a user 130 is saved page-by-page into data storage 260. Once user 130 either submits an electronic form or goes to the next page of the electronic form, form entry program 271 extracts the data from the electronic form and stores it into data storage 260. Thereafter, when user 130 subsequently reenters the form process and selects the electronic form, form entry program 271 retrieves the data from data storage 260 and displays it in the appropriate fields in the electronic form (or “snaps” the data into the form). In an alternate example, the data is stored in secondary storage 230 until the electronic form is printed. Therefore, if a user 130 chooses to exit the form process before printing the electronic form, and subsequently reenters the form process and selects the same electronic form, form entry program 271 retrieves the data from secondary storage 230 and displays it in the appropriate fields in the electronic form (or “snaps” the data into the form).

### Information Sources and Distribution

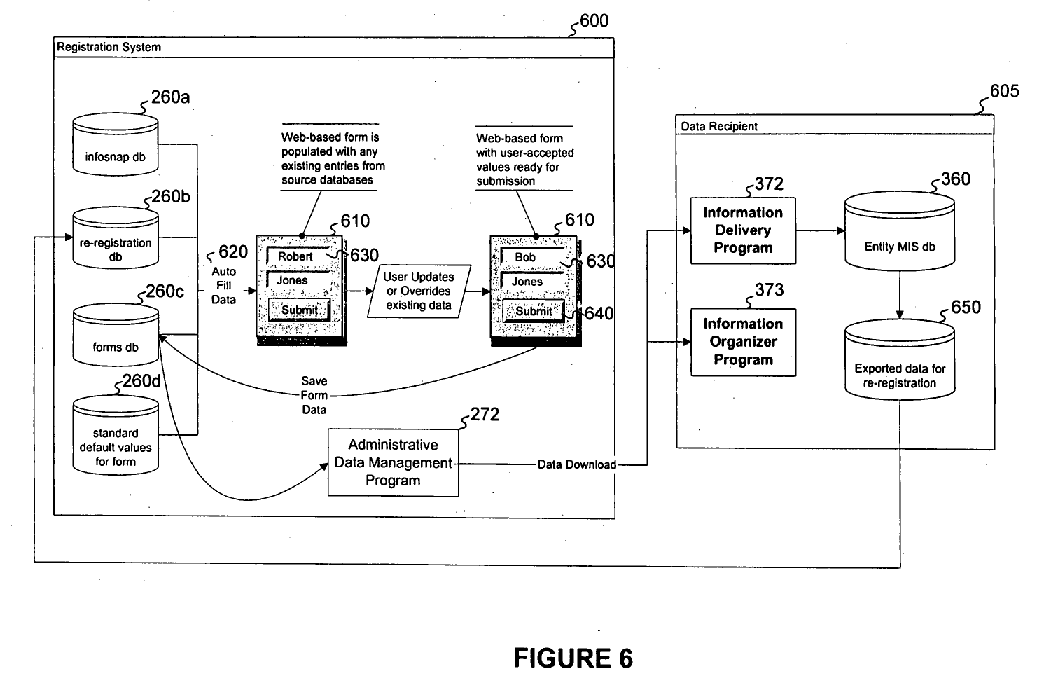

FIG. 6 provides a flowchart of the data flow of information within a system 100. As shown in FIG. 6, a form system environment 600 may communicate with an environment 605 for data recipient 120 through an administrative data management program 272. Data storage 260 may include, but is not limited to, a form system database 260a, a re-registration database 260b, a forms database 260c, and a database that includes standard default values for the forms 260d. Form system database 260a may include information about users 130 who are registered to access the form system 101, data recipients 120 who are registered with the form system 101, commonly used information for forms, accounting information, etc. For convenience, form system database 260a is referred to as the “infosnap” database. Re-registration database 260b may include information about existing registrants that may be used by the form system 101 to snap data into electronic forms to allow users to re-register applicants without having to re-supply information into the electronic forms. Forms database 260c may include information that user's 130 have supplied for electronic forms.

A form entry program 271 includes an auto fill data program 620 that determines the type of information to snap into electronic forms and where within the form system 101 to retrieve the data that is snapped into the electronic forms. For example, if a user 130 requests to access a form to re-register with a data recipient 120, auto fill data program 620 may retrieve form information from re-registration database 260b and snap it into the electronic form. As another example, a form owned by data recipient A and data recipient B have matching fields, for example, applicant name, date of birth, and information about the applicant's parents. User 130 may request to fill out an electronic form with data recipient B, and has previously supplied information in the electronic form prepared for data recipient A. Form entry program 271 provides for supplying the matching fields in the electronic form belonging to data recipient B with information that was provided in the matching fields of the electronic form belonging to data recipient A. Form entry program 271 may call auto fill data program 620 to retrieve from forms database 260c information for the matching fields that was supplied in the electronic form for data recipient A, and from database 260d standard default values for the electronic form for data recipient B. Auto fill data program 620 detects and handles any collisions in snapping data into electronic forms. For example, data recipient A's electronic form includes a checkbox that is “checked” for sending a confirmation notification of the registration to the applicant's parent or guardian. Data recipient B's electronic form includes a similar checkbox, but the default value for the checkbox is “not checked.” Auto fill program 620 detects that the default value for data recipient B is “not checked” and overrides the value that was retrieved for the checkbox that is associated with the electronic form for data recipient A, such that the checkbox is “not checked” in the electronic form for data recipient B.

In yet another example, a user 130 may make a request to a form entry program 271 to access an electronic form 610 to register with a new data recipient 120. Form entry program 271 calls auto fill data program 620 to retrieve commonly used information associated with user 130 from the infosnap database 260a and standard default values for the electronic form from database 260d. Auto fill data program 620 retrieves the electronic form information and snaps it into the form 610 and displays the form to the user 130. The user may now edit/update the electronic form 610. Form entry program 271 may store in forms database 260c edits or updates that user 130 made to the information in the electronic form. For example, user 130 may update information in the electronic form 610 by changing an applicant's name 630 from “Robert” to “Bob.” User 130 may then click the “Submit” button 640 to update the information. Form entry program 271 retrieves the data in the electronic form 610 and replaces the existing value “Robert” in the forms database 260c for the associated electronic form with the updated value “Bob.”

Administrative data management program 272 enables data recipients 120 to share information with a form system 101. For convenience, the program is referred to herein as an “administrative management” program. Administrative data management program 272 provides a secure encrypted link to the form system 101 and provides access to the data stored in form system 101.

A data recipient 120 environment 605 may include program 372 or program 373, an entity database 360 and a secondary storage region 330 for storing exported data for re-registration 650. Programs 372 and 373 are computer programs that provide for allowing data recipients 120 to access and/or share information with the form system 101. For convenience, the programs are referred to herein as “info delivery” and “information organizer” programs.

An information delivery program 372 is used by data recipients 130 who have management information systems (“MIS”) and want to share electronic form information with a form system 101. The electronic form information may include, for example, one or more electronic forms and/or information from one or more of the electronic forms. Data recipients 120 may supply to form system 101 information about users 130 who have previously registered with the data recipients 120, or configuration information, such as configuration information for forms. For example, a data recipient 120 may export electronic form information from its MIS database 360 into an export file 650. Data recipient 120 may then make a request through an information delivery program 372 to import the requested electronic form information into form system 101. Information delivery program 372 sends the request through network 110 to administrative data management program 272. Administrative data management program 272 receives the request and authenticates data recipient 120. Responsive to a successful authentication of data recipient 120, administrative data management program 272 imports the requested electronic form information stored in the export file 650 into the re-registration database 260b. Data transmissions over network 110 are made using secure network connections and the data may be encrypted prior to transmission, and subsequently decrypted after it is transmitted to its destination.

As another example, an administrator may make a request through administrative data management program 272 to export form information from the data recipient 120 MIS database 360 and to import it into the form system 101. Administrative data management program 272 sends the request to an information delivery program 372 through network 110. The form information may include, for example, electronic form information, such as electronic application forms, registration forms, information from one or more of the electronic forms, etc. Information delivery program 372 exports the requested form information from data recipient 120 MIS database 360 into an export file 650. Information delivery program 372 sends the export file 650 to administrative data management program 272 through network 110. Administrative data management program 272 receives the export file 650, and imports the requested form information stored in the export file 650 into re-registration database 260b.

As yet another example, data recipient 120 may make a request through an information delivery program 372 to send to form system 101 configuration information. Information delivery program 372 sends the request and configuration information through network 110 to administrative data management program 272. Administrative data management program 272 receives the request and configuration information, authenticates data recipient 120, and responsive to a successful authentication of data recipient 120, stores the configuration information in data storage 260.

Form system 101 may supply to data recipients 120 registration information, form information, administrative information, medical information, reports, etc. The medical information may include, for example, an electronic copy of a medical examination form signed by a physician or a health care provider, a medical history form, etc.

In one example of form system 101 supplying information to a data recipient 101, data recipient 120 makes a request to information delivery program 372 for a report of all applicants who are registered for the data recipient's camp for the Summer of the year 2001. Information delivery program 372 sends the request to administrative data management program 272 through network 110. Administrative data management program 272 receives the request and may authenticate data recipient 120. Responsive to a successful authentication of data recipient 120, administrative data management program 272 retrieves the requested information from data storage 260, generates the requested report, and sends the report to information delivery program 372 through network 110. Information delivery program 372 receives the report and displays the report. Alternatively, information delivery program 372 may print the report.

In another example of form system 101 supplying information to data recipient 101, data recipient 120 makes a request through information delivery program 372 to view the forms of all applicants who are registered for the data recipient's camp for the Summer of the year 2001. Information delivery program 372 sends the request to administrative data management program 272 through network 110. Administrative data management program 272 receives the request and authenticates data recipient 120. Responsive to a successful authentication of the data recipient 120, administrative data management program 272 retrieves the requested forms from data storage 260 and sends the retrieved forms to information delivery program 372 through network 110. Information delivery program 372 receives the forms and displays them to the data recipient 120. Alternatively, information delivery program 372 may print the forms.

Information supplied by form system 101 to data recipients 120 may alternatively be provided in various file formats, which may include, for example, XML, HTML, ASCII text, tab delimited, comma separated value (“CSV”), Microsoft Access database (“MDB”) format, and in the format of a Microsoft Excel worksheet.

An information organizer program 373 is used by data recipients 130 who do not have a formal management information system or have a limited management information system, and who require access to registration information that is available through the form system 101. For example, a data recipient 120 may make a request through an information organizer 373 program for a copy (or export) of the electronic form information for all applicants who are registered for the data recipient's camp for the Summer of the year 2001. The electronic form information may include, for example, an electronic application form or registration form, and/or information from one or more of the electronic forms. Information organizer program 373 sends the request to administrative data management program 272 over network 110. Administrative data management program 272 receives the request and authenticates data recipient 120. Responsive to a successful authentication of data recipient 120, administrative data management program 272 retrieves the requested electronic form information from data storage 260, and sends the retrieved form information through network 110 to information organizer program 373. Information organizer program 373 receives the requested electronic form information. Information organizer program 373 may now automatically massage the form information into a format that can be directly imported into a data recipient's 120 database, such as a Microsoft Access database or into a file format that is known to various software utilities, such as Microsoft Excel. The automatic massaging may be done according to known methods. Alternatively, the request may include a format request that administrative data management program 272 place the electronic form information into a requested file format prior to sending the electronic form information as a file to information organizer program 373.

### Organizing and Sharing Registration Information

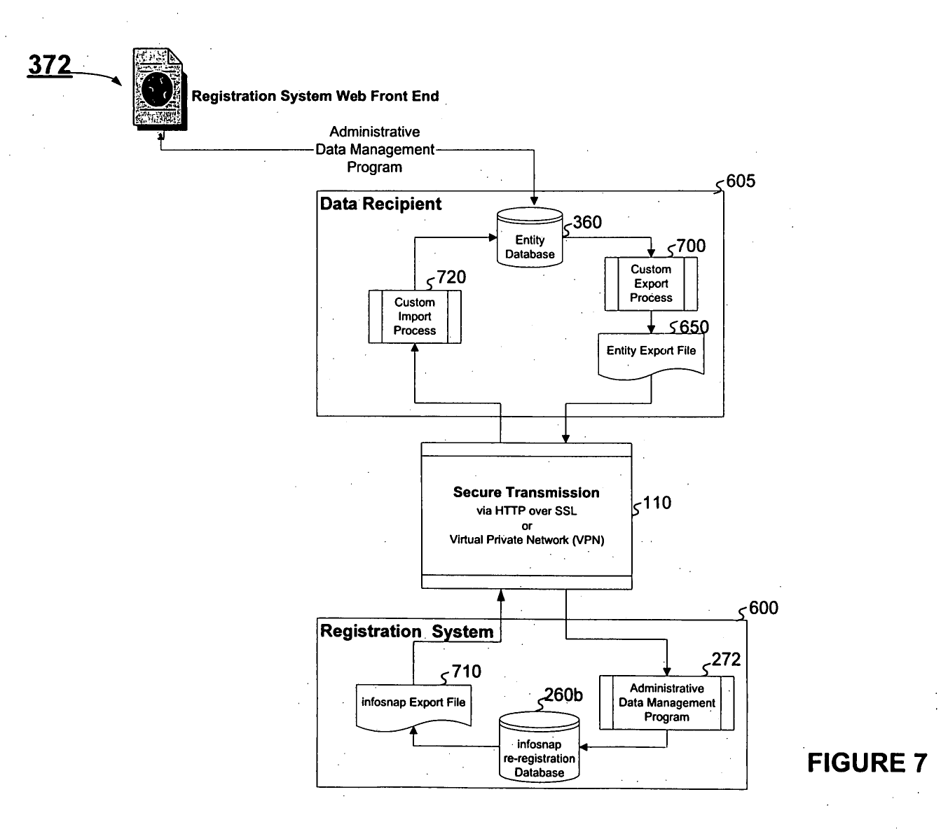

FIG. 7 is a flowchart showing processing for sharing information with a data recipient having a management information system (“MIS”). As shown in FIG. 7, a data recipient 120 may use a custom export program 700 to export data from the data recipient's 120 MIS database 360 into an export file 650. The custom export program 700 may be provided by data recipient 120 or a third party. Data recipient 120 may then request through an information delivery program 372 that the export file 650 be imported into form system 101. The export file may include, for example, one or more electronic forms, such as electronic application or registration forms. Information delivery program 372 sends the request and the export file 650 to administrative data management program 272 through network 110. Administrative data management program 272 receives the request and the export file 650 and imports the data in the export file 650 into data storage 260. For example, if the request is to import re-registration information, administrative data management program 260b imports the data in the export file 650 into re-registration database 260b.

A data recipient 120 may send a request to an information delivery program 372 to export data from form system 101. Information delivery program 372 sends the request to administrative data management program 272. Administrative data management program 272 receives the request. Next, administrative data management program 272 exports (or copies) the requested data from data storage 260 into an export file 710 in a format that is known to a custom import program 720. Thereafter, administrative data management program 272 sends the export file 710 to information delivery program 372 through network 110. Information delivery program 372 receives the export file 710 and calls a custom import program 720 to import the data in the export file 710 into the data recipient's 120 MIS database 360. Custom import program 720 may be provided by data recipient 120 or a third party.

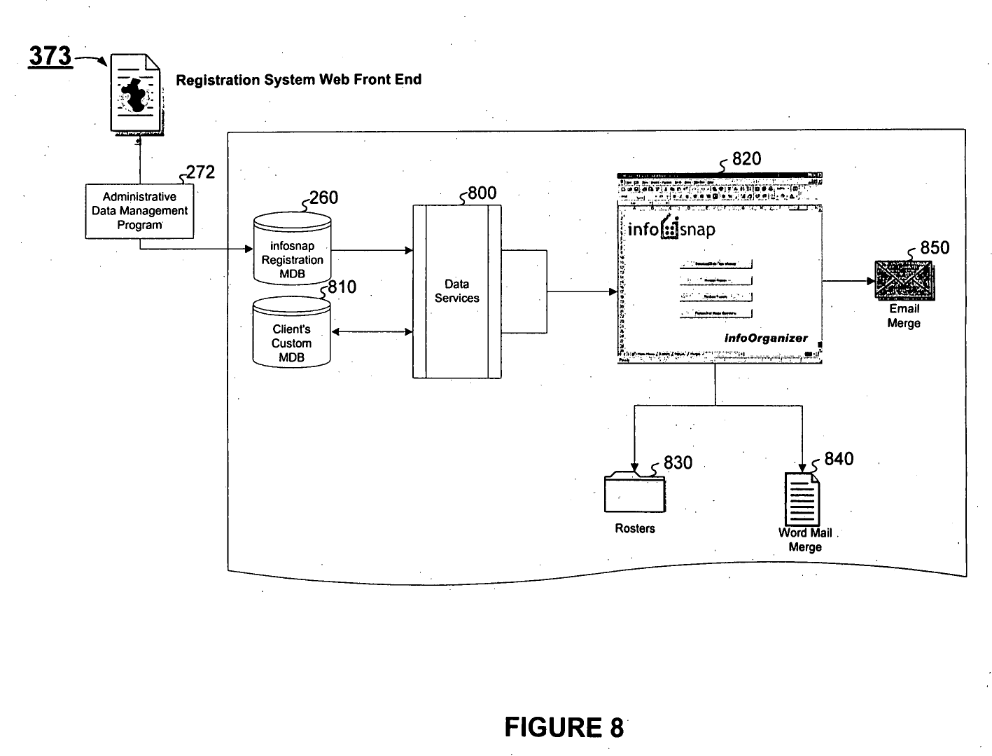

FIG. 8 is a flowchart showing processing for sharing information with a data recipient that does not have a management information system. As shown in FIG. 8, a data recipient 120 may make a request through information organizer program 373 for information to be downloaded from form system 101. The request may include a request for electronic form information for all applicants who were registered for the data recipient's 120 camp for the year 2000. The electronic form information may include one or more electronic forms, such as electronic application or registration forms, and/or information from one or more of the electronic forms. Information organizer program 373 sends the request to administrative data management program 272 through network 110. Administrative data management program 272 receives the request, retrieves the requested electronic form information from data storage 260, and sends the requested electronic form information to information organizer program 373 through network 110. Information organizer program 373 receives the requested electronic form information and may call a data services program 800, such as Microsoft Jet Engine, to import the electronic form information into a database 810, for example, a Microsoft Access database.

Alternatively, data recipient 120 may make a request through information organizer program 373 for the electronic form information to be downloaded from form system 101 into a file in a specified file format, for example, a Microsoft Excel worksheet. Information organizer program 373 sends the request to administrative data management program 272 through network 110. Administrative data management program 272 receives the request, retrieves the requested electronic form information from data storage 260, formats the requested electronic form information into a Microsoft Excel worksheet file, and sends the formatted electronic form information as a file to information organizer program 373 through network 110. Information organizer program 373 receives the requested electronic form information and stores it in secondary storage 330. Thereafter, information organizer program 373 may call a data services program 800, such as a Microsoft Excel 820, to display the formatted electronic form information to data recipient 120. Alternatively, information organizer program 373 may request the data services program 800 to generate rosters 830 from the electronic form information, and/or generate Microsoft Word mail merges 840 or email merges 850 for sending the data recipients mailings to applicants specified in the application information.

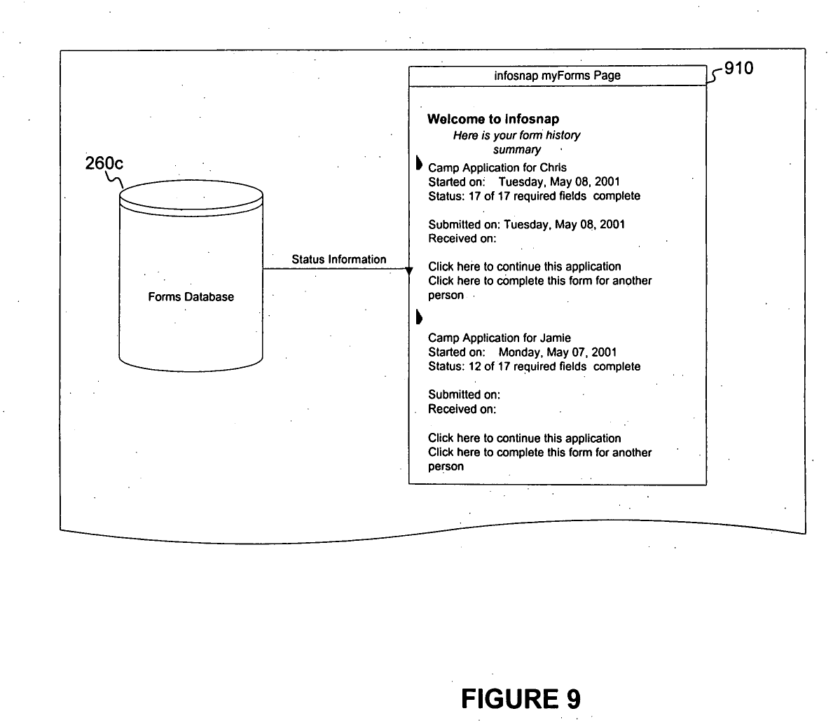

Form entry program 271 may track the status of electronic forms in form system 101. Form entry program 271 uses a tracking feature to navigate to and resume a form entry process. As shown in FIG. 9, form entry-program 271 may display, in a Web page or a graphical user interface 910, information about the status of electronic forms for a user 130. Form entry program 271 may store and retrieve tracking information in/from forms database 260c about electronic forms known to form system 101. Form entry program 271 tracks information such as the time a form was accessed, which user accessed the form, completion status of the form, date on which the form was submitted to a data recipient 120, etc. In addition, form entry program 271 may provide a status report to a user 130 regarding individual electronic forms or all electronic forms that are associated with the user 130 in the form system 101. The status report may be displayed to the user and/or printed. Further, form entry program 271 may display a history of all electronic forms that a user 130 has completed. User 130 may view any of the forms and print them.

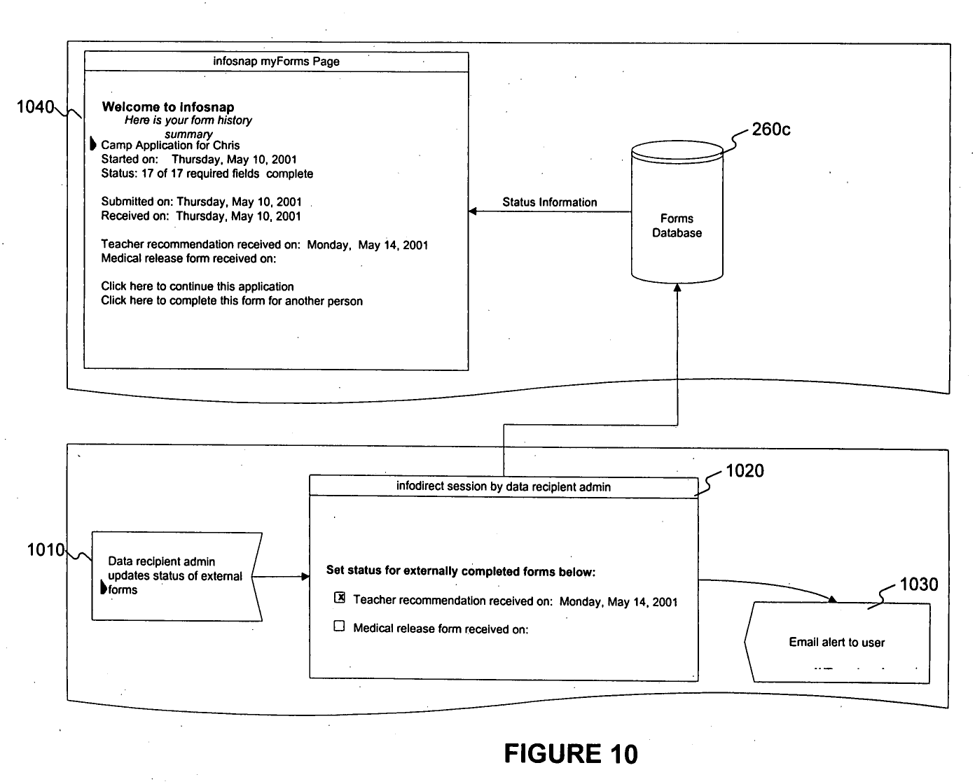

Form entry program 271 may track the status of forms that were filled out in an environment that is external to form system 101, for example, a medical release form completed by a parent, a medical history form completed by a physician, a permission form completed by a parent, etc. A data recipient 120 may receive an external form from, for example, a user 130 or a physician. As shown in FIG. 10, data recipient 120 may access information delivery program 372 to update the status of the external form on behalf of a user 130 (step 1010). Information delivery program 372 may store information about the external form in forms database 260c. The information may include, for example, the external form, type of form, date the external form was received in form system 101, information identifying the data recipient 120 for which the form was received, etc (step 1020). Information delivery program 372 may now send an email notification to a user 130 associated with the external form, to inform the user 130 of the form system's receipt of the external form (step 1030). User 130 may now request, from the form system 101, information about her form history. Form entry program 271 may provide a status report to user 130 regarding individual forms or all forms that are associated with user 130 in the form system 101. Further, form entry program 271 may display a summary of the form history for user 130 (step 1040). User 130 may view any of these forms and print them.

Finally, form system 101 may include program 273 for securely receiving medical or emergency information for applicants registered with data recipients 120. The medical information may be received, for example, from users 130, data recipients 120, and health care providers. For convenience, the program is referred to as an “information safety” program. An information safety program 273 also provides for verifying the authenticity of medical records received from health care providers. In one example, an information safety program 273 receives a request from a user 130 to send medical information for an applicant to a data recipient 120. Information safety program 273 receives the request, authenticates the user 130, and responsive to a successful authentication of the user 130, retrieves the requested medical information from data storage 260 and sends the requested medical information to data recipient 120.

In another example, users 130 supply authorization codes to data recipients 120 that authorizes the data recipients 120 to gain access to medical records that are associated with the authorization code for medical emergencies. A data recipient 120 sends a request to an information safety program 273 to send the medical records to a specified health care provider. The request may include an authorization code. Information safety program 273 receives the request, authenticates the authorization code, and responsive to a successful authentication, sends the medical records associated with the authorization code to the health care provider.

### Conclusion

The foregoing description of preferred embodiments of the present invention provides illustration and description, but is not intended to be exhaustive or to limit the invention to the precise form disclosed. Modifications and variations are possible in light of the above teachings or may be acquired from practice of the invention. The scope of the invention is defined by the claims and their equivalents.

1-27. (canceled)

28. A method for automatically filling out an electronic form comprising:
selecting a hyperlink to an affinity page in a system's web site;
storing a set of information for the electronic form retrieved from the web site;
receiving a request for access to the electronic form;
retrieving the set of information for the electronic form;
placing the retrieved set of information into the electronic form;
displaying the electronic form;
receiving updated information in the electronic form; and
updating the set of information using the updated information.

29. The method of claim 28, further comprising automatically providing, in real-time, the updated information to a data recipient.

30. The method of claim 28, wherein storing the set of information comprises storing the set of information in a database.

31. The method of claim 28, further comprising:
displaying a fee to a user, the fee being for at least one of use of the electronic form and a fee for a data recipient; and
receiving payment of the fee from the user.

32. The method of claim 28, further comprising:
obtaining the set of information using a plurality of pages;
saving, to a central database, information from each page when the page is complete; and
combining the information from each page to form the set of information.

33. The method of claim 28, further comprising:
receiving a request to fill a second electronic form;
retrieving the set of information from the first electronic form;
detecting a collision between a default value of the second electronic form and a value of the first electronic form; and
overriding the default value of the second electronic form using the value of the first electronic form.

34. The method of claim 28, further comprising exporting, from a data recipient to a database, the set of information.

35. A method for automatically supplying electronic form information to a data recipient comprising:
receiving a request from the data recipient for the electronic form information;
retrieving the requested electronic form information;
formatting the requested electronic form information in a format specified by the data recipient; and
posting the formatted electronic form.

36. A method for automatically filling out an electronic form comprising:
generating the electronic form;
storing a set of information for the electronic form using an administrative data management program;
receiving a request for access to the electronic form;
retrieving the set of information for the electronic form;
placing the retrieved set of information into the electronic form using an auto fill data program that determines the type of information to snap into electronic forms and where to retrieve the information from;
displaying the electronic form;
receiving updated information in the electronic form; and
storing the updated information for the set of information for use in filling out the electronic form.

37. The method of claim 36, further comprising indicating, using the administrative data management program, a completion status of storing the set of information into the electronic form.

38. A method for automatically filling out an electronic form comprising:
storing a set of information for the electronic form in a system database;
receiving a request for access to the electronic form in a forms system database;
retrieving, from the system database, the set of information for the electronic form;
placing the retrieved set of information into the electronic form;
placing default information from a default database into the electronic form; and
receiving updated information in the electronic form.

39. The method of claim 38, further comprising registering a user using a registration database.

40. The method of claim 39, further comprising:
displaying a release page to the user, the release page including terms and conditions specified by a data recipient; and
receiving an indication of at least one of an acceptance of the terms and conditions and a rejection of the terms and conditions.

41. The method of claim 38, wherein the receiving the updated information comprises receiving private information using a secure connection.

42. A system for automatically filling out an electronic form, the system comprising:
computer program means for selecting a hyperlink to an affinity page in a system's web site;
computer program means for storing a set of information for the electronic form retrieved from the web site;
computer program means for receiving a request for access to the electronic form;
computer program means for retrieving the set of information for the electronic form;
computer program means for placing the retrieved set of information into the electronic form;
computer program means for displaying the electronic form;
computer program means for receiving updated information in the electronic form; and
computer program means for updating the set of information using the updated information.

43. The system of claim 42, further comprising computer program means for automatically providing, in real-time, the updated information to a data recipient.

44. The system of claim 42, further comprising:
computer program means for displaying a fee to a user, the fee being for at least one of use of the electronic form and a fee for a data recipient; and
computer program means for receiving payment of the fee from the user.

45. The system of claim 42, further comprising:
computer program means for obtaining the set of information using a plurality of pages;
computer program means for saving, to a central database, information from each page when it the page is complete; and
computer program means for combining the information from each page to form the set of information.

46. The system of claim 42, further comprising:
computer program means for receiving a request to fill a second electronic form;
computer program means for retrieving the set of information from the first electronic form;
computer program means for detecting a collision between a default value of the second electronic form and a value of the first electronic form; and
computer program means for overriding the default value of the second electronic form using the value of the first electronic form.

47. A system for automatically supplying electronic form information to a data recipient, the system comprising:
computer program means for receiving a request from the data recipient for the electronic form information;
computer program means for retrieving the requested electronic form information;
computer program means for formatting the requested electronic form information in a format specified by the data recipient; and
computer program means for posting the formatted electronic form.

48. A system for automatically filling out an electronic form, the system comprising:
means for generating the electronic form;
computer program means for storing a set of information for the electronic form using an administrative data management program;
means for receiving a request for access to the electronic form;
computer program means for retrieving the set of information for the electronic form;
computer program means for placing the retrieved set of information into the electronic form using an auto fill data program that determines the type of information to snap into electronic forms and where to retrieve the information from;
computer program means for displaying the electronic form;
means for receiving updated information in the electronic form; and
computer program means for storing the updated information for the set of information for use in filling out the electronic form.

49. A system for automatically filling out an electronic form, the system comprising:
computer program means for storing a set of information for the electronic form in a system database;
computer program means for receiving a request for access to the electronic form in a forms system database;
computer program means for retrieving, from the system database, the set of information for the electronic form;
computer program means for placing the retrieved set of information into the electronic form;
computer program means for placing default information from a default database into the electronic form; and
computer program means for receiving updated information in the electronic form.

50. The system of claim 51, wherein the receiving the updated information comprises receiving private information using a secure connection.
